(19) United States
(12) Patent Application Publication
(10) Pub. No.: US 2024/0394975 A1
(43) Pub. Date: Nov. 28, 2024

(54) INFORMATION PROCESSING DEVICE, INFORMATION PROCESSING METHOD, AND INFORMATION PROCESSING PROGRAM

(71) Applicant: Sony Group Corporation, Tokyo (JP)

(72) Inventor: Yoshinori OHASHI, Tokyo (JP)

(73) Assignee: Sony Group Corporation, Tokyo (JP)

(21) Appl. No.: 18/690,751

(22) PCT Filed: Feb. 22, 2022
(86) PCT No.: PCT/JP2022/007074

§ 371 Date: Mar. 11, 2024

(30) Foreign Application Priority Data
Sep. 30, 2021 (JP) 2021-161300

(51) Int. Cl. G06T 17/05; G06T 7/11; G06T 7/12; G06T 7/33; G06T 15/04; G06T 19/20

(52) U.S. Cl. CPC G06T 17/05; G06T 7/11; G06T 7/12; G06T 7/344; G06T 15/04; G06T 19/20; G06T 2207/10028; G06T 2210/56; G06T 2219/008; G06T 2219/2004; G06T 2219/2021

(57) ABSTRACT

An information processing device (100) includes: an acquisition unit (131) that acquires a first 3D model generated by capturing a first region in a real space and map data corresponding to the first region; and a model processing unit (132) that divides the first 3D model into a plurality of second 3D models on a basis of section information included in the map data.

### FIELD

The present disclosure relates to an information processing device that enables flexible use of a 3D model, an information processing method, and an information processing program.

### BACKGROUND

In recent years, user-generated content (UGC), which is content generated by a plurality of users, has attracted attention. In the UGC, a 3D model can be constructed using an image captured by an individual user's terminal called a client or the like, or in a case where the user performs a certain operation at a certain position in the real world, the operation can be reflected in the position in a map service.

For example, there is known a technology in which an external server updates map data on the basis of a three-dimensional map created on a client device, and an image usable for augmented reality (AR) is generated on the client device by using the map data (for example, Patent Literature 1).

### CITATION LIST

### Patent Literature

Patent Literature 1: JP 2020-526829 A

### SUMMARY

### Technical Problem

For example, the user captures the real world and creates a 3D model by using a technology of simultaneous localization and mapping (SLAM). The 3D model created in this manner is one huge model in which all the surrounding environments are integrated into one. Such a huge model is large in size and difficult to use. That is, in a case where data obtained by capturing the real world is applied to various applications, it is desirable to use the data flexibly, for example, by dividing the 3D model for each object such as a building or a tree.

The present disclosure proposes an information processing device that enables flexible use of a 3D model, an information processing method, and an information processing program.

### Solution to Problem

In order to solve the above problems, an information processing device according to an embodiment of the present disclosure includes an acquisition unit that acquires a first 3D model generated by capturing a first region in a real space and map data corresponding to the first region, and a model processing unit that divides the first 3D model into a plurality of second 3D models on a basis of section information included in the map data.

### BRIEF DESCRIPTION OF DRAWINGS

FIG. 1 is a diagram illustrating an overview of an information processing system according to an embodiment.

FIG. 2 is a flowchart illustrating a flow of information processing executed by a client.

FIG. 3 is a diagram illustrating a first 3D model according to the embodiment.

FIG. 4 is a diagram for describing collation processing according to the embodiment.

FIG. 5 is a diagram illustrating an example of a geopose database according to the embodiment.

FIG. 6 is a flowchart illustrating a flow of division processing executed by a client.

FIG. 7 is a diagram (1) for describing division processing according to the embodiment.

FIG. 8 is a diagram (2) for describing division processing according to the embodiment.

FIG. 9 is a diagram (3) for describing division processing according to the embodiment.

FIG. 10 is a diagram (4) for describing division processing according to the embodiment.

FIG. 11 is a diagram illustrating a second 3D model according to the embodiment.

FIG. 12 is a diagram illustrating a configuration example of a client according to the embodiment.

FIG. 13 is a diagram illustrating a configuration example of a VPS server according to the embodiment.

FIG. 14 is a diagram illustrating a configuration example of a service server according to the embodiment.

FIG. 15 is a sequence diagram illustrating a flow of processing according to the embodiment.

FIG. 16 is a diagram illustrating an overview of an information processing system according to a modification example.

FIG. 17 is a diagram illustrating a configuration example of a VPS server according to the modification example.

FIG. 18 is a hardware configuration diagram illustrating an example of a computer that implements a function of a client.

### DESCRIPTION OF EMBODIMENTS

Embodiments will be described in detail below with reference to the drawings. Note that, in each of the following embodiments, the same parts are denoted by the same reference numerals, and an overlapped description will be omitted.

The present disclosure will be described according to an order of items to be described below.
1. Embodiment
1-1. Overview of information processing according to embodiment
1-2. Configuration of client according to embodiment
1-3. Configuration of VPS server according to embodiment
1-4. Configuration of service server according to embodiment
1-5. Procedure of processing according to embodiment
1-6. Modification example according to embodiment
2. Another embodiment
3. Effects of information processing device according to present disclosure
4. Hardware configuration

### 1. Embodiment

### 1-1. Overview of Information Processing According to Embodiment

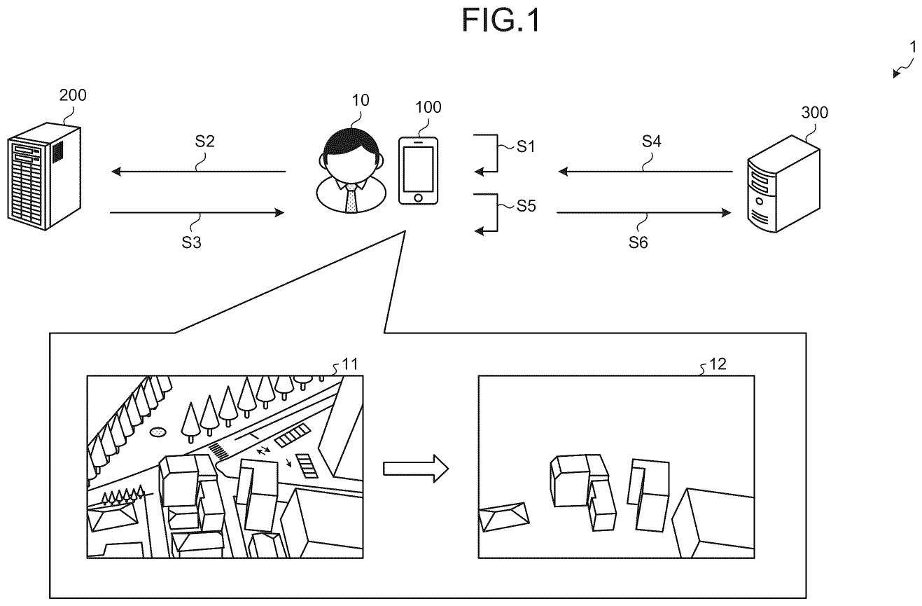

An example of information processing according to an embodiment of the present disclosure will be described with reference to FIG. 1. FIG. 1 is a diagram illustrating an overview of an information processing system 1 according to the embodiment. The information processing system 1 divides one huge 3D model generated by capturing the real world by using a technology such as SLAM, and executes information processing using the 3D model newly generated by the division for various services. FIG. 1 illustrates constituent elements of the information processing system 1 that executes information processing according to the embodiment.

A client 100 is an information processing device used by a user 10. For example, the client 100 is a smartphone, a tablet terminal, a digital camera, or the like. In accordance with an operation of the user 10, the client 100 captures the real world by using an image sensor, a distance measuring sensor, or the like, and generates a 3D model.

A visual positioning system (VPS) server 200 is an information processing device that receives an image as an input and performs processing of giving positional information (for example, an x coordinate, a y coordinate, a z coordinate, and the like in a Euclidean space) corresponding to the image, orientation information (for example, Euler angles, rotation matrix, quaternion, and the like). For example, the VPS server 200 is a cloud server. The VPS server 200 may have global map data or the like in order to perform processing related to the positional information as described above.

A service server 300 is an information processing device that provides various services. In the embodiment, for example, the service server 300 provides a map service that transmits map data to the user 10 in response to a request. For example, the service server 300 is a cloud server.

Note that each device in FIG. 1 conceptually illustrates a function in the information processing system 1, and can take various modes depending on the embodiment. For example, each device may include two or more devices different for each function to be described later. Furthermore, each device is not limited to the illustrated number, and there may be a plurality of devices. For example, as the service server 300, there may be a plurality of servers that provide various different services.

As described above, the client 100 captures the real world by using various sensors to generate a 3D model. Content generated on an end user side such as the client 100 is referred to as UGC. The 3D model of the UGC is shared by the service server 300 and the like, and is utilized for, for example, an augmented reality (AR) technology. Specifically, in the map service, navigation display can be performed so as to be superimposed on the position, or a virtual game character can be displayed in the smartphone that captures an image of the real world.

However, there are some problems in using the 3D model transmitted from the client 100 for various services. The 3D model generated by the client 100 is one huge model in which all the surrounding environments are integrated into one. Such a huge model is large in size and difficult to use on a service side. Furthermore, for example, the service side may take a method of dividing the 3D model into meshes and acquiring neighboring meshes in stages according to the current point, but it is difficult to accurately match the position on the map with the 3D model divided into meshes. That is, even when the service side attempts to use content such as a building captured in the real world through mesh division for a service, the service side cannot perform division with sufficient quality in a state in which there is an error in units of meters. Furthermore, it is technically difficult to automatically perform division in consideration of the meaning of an individual building or the like from a three-dimensional shape of the 3D model.

The information processing system 1 according to the present disclosure solves the above-described problem by using processing to be described below. That is, the information processing system 1 acquires a 3D model generated by capturing a region (hereinafter, referred to as a “first region” for distinction) to be captured in the real space and map data corresponding to the first region. Then, the information processing system 1 divides the 3D model into a plurality of detailed 3D models on the basis of section information included in the map data. Although details will be described later, the information processing system 1 collates the 3D model generated by the client 100 with the positional information on the map data, and further divides the 3D model by using the section information (road or the like) included in the map data used for the collation. As a result, the information processing system 1 according to the present disclosure enables flexible use of the 3D model generated by the client 100, for example, in a map service or a game service using the AR technology. Note that, in the following description, for distinction, a 3D model before division, generated by the client 100, may be referred to as a “first 3D model” and the divided 3D model may be referred to as a “second 3D model”. Hereinafter, the information processing according to the present disclosure will be described along a flow.

First, the overview of the information processing according to the present disclosure will be described with reference to FIG. 1. First, the client 100 captures the real world and generates a 3D model according to the operation of the user 10 (Step S1). For example, the client 100 generates the 3D model of the first region by capturing an image of the real world with a camera (image sensor) included in the client's own device. The 3D model generated by the client 100 is one huge 3D model in which the entire first region is integrated. Note that, in the following description, for distinction, a 3D model before division, generated by the client 100, may be referred to as a “first 3D model”.

The client 100 transmits, to the VPS server 200, the generated first 3D model, image information corresponding to the 3D model or a feature point (referred to as a key frame or the like) extracted from the image information (Step S2). The VPS server 200 transmits the position/orientation information corresponding to the 3D model to the client 100 (Step S3). As described above, the processing of obtaining the position/orientation information using the image as an input may be referred to as localization.

Subsequently, the client 100 acquires map data corresponding to the first region from the service server 300 that provides a map service (Step S4). Note that the map data is, for example, data provided by authorities that have jurisdiction over the land of the country, a private map data providing company, or the like, and is data representing a map in a vector tile format. The data provided in a vector tile format has advantages in terms of use, for example, tags to roads and facilities on a map are attached, and editing processing such as rotating and downsizing the map is facilitated.

The client 100 determines whether buildings, facilities, and the like match between the first 3D model and the acquired map data. For example, the client 100 determines whether or not a 3D model of a building, a facility, or the like exists in the information (hereinafter, referred to as “section information”) for dividing the map data for each section. The section information is, for example, attribute information of a road attached to map data, or the boundary of the building or the like in a case where there is data in which a building attribute is attached to map data. That is, the client 100 collates the 3D model with the map data on the basis of the section information. Then, when the first 3D model can be collated with the map data, the client 100 divides the first 3D model by using the section information of the map data (Step S5). As an example, the client 100 divides the first 3D model into sections by regarding the road included in the map data as a boundary.

Moreover, although details will be described later, the client 100 not only simply performs division with the road as the boundary, but also further divides the first 3D model finely through plane detection of the 3D model and determination as to whether or not the object included in the 3D model is a building. Specifically, the client 100 divides the first 3D model until the section includes only a building as an object.

Thereafter, the client 100 registers the divided second 3D model in the service server 300 (Step S6). As a result, the service server 300 can use the second 3D model generated by the client 100 for various services. Specifically, the service server 300 can dispose a new 3D model generated by the client 100 on the map service, and superimpose a character on the 3D model in an AR application or a game linked to the map service.

As described above, in the information processing system 1 according to the present disclosure, by dividing the first 3D model into a plurality of the second 3D models on the basis of the section information included in the map data, it is possible to flexibly use the 3D model.

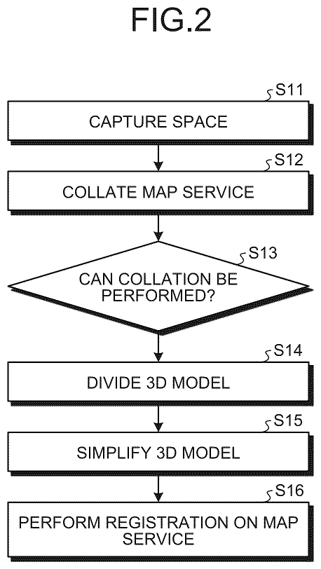

Next, details of the processing from Step S1 to Step S6 will be described with reference to FIG. 2 and subsequent drawings.

First, the overall flow of information processing executed by the client 100 will be described with reference to FIG. 2. FIG. 2 is a flowchart illustrating a flow of the information processing executed by the client 100. As illustrated in FIG. 2, first, the client 100 captures a space (the real world) and generates a first 3D model (Step S11).

At this time, the client 100 acquires, from the VPS server 200, geopose information that is global position/orientation information including information regarding latitude, longitude, elevation, and azimuth. The client 100 collates the first 3D model with the map service by using such information (Step S12). Specifically, the client 100 specifies geopose information, acquires map data corresponding to the position from the map service, and collates the 3D model with the map.

The client 100 determines whether or not collation with the map service has been successfully performed (Step S13), and in a case where the collation cannot be performed, data such as geopose information is newly acquired or an error is returned to the user 10.

When the collation with the map service can be performed, the client 100 divides the first 3D model into second 3D models on the basis of the collated data (Step S14). Moreover, the client 100 simplifies the 3D model, for example, the objects (that is, building) included in each of the divided second 3D models is replaced (Step S15). For example, when the 3D model (that is, the object) of the space divided using the boundary information of the map service is a cuboid building, the client 100 simplifies the 3D model by replacing the 3D model with six planes.

Then, the client 100 transmits the generated new second 3D model to the service server 300 and performs registration on the map service (Step S16). Specifically, the client 100 registers the divided and simplified 3D model on the corresponding latitude and longitude of the map service. Therefore, the service server 300 can draw the 3D model on the map as a 3D map representation or provide a virtual 3D space to the user 10 at a remote location.

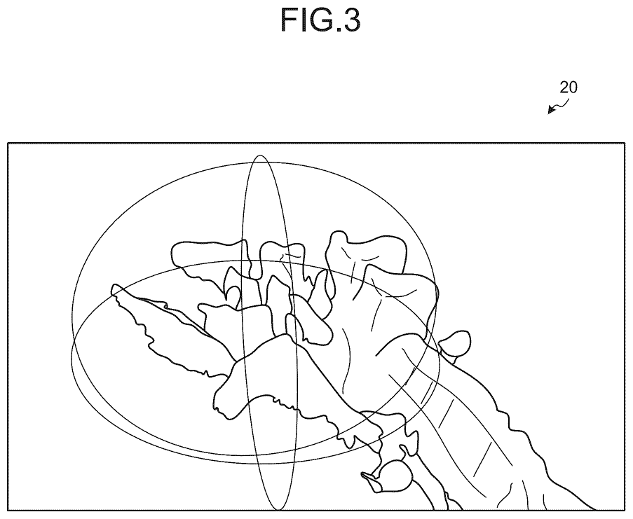

Next, details of the processing of dividing the first 3D model will be described along a flow with reference to FIG. 3 and subsequent drawings. FIG. 3 is a diagram illustrating the first 3D model according to the embodiment.

FIG. 3 illustrates a 3D model 20 as an example of the first 3D model. The 3D model 20 is obtained by three-dimensionally shaping point cloud data acquired by the SLAM technology. For example, the 3D model 20 is a model generated by the user 10 trying to capture a road while walking on the road. As illustrated in FIG. 3, the 3D model 20 is an integrated 3D model without division for each object. Furthermore, in a state in which the image capturing is performed by the user 10, the shape of each building becomes ambiguous, and it becomes difficult to display the 3D model 20 in a rectangular shape. This is because, in a case where the user 10 who is walking captures an image of a building, the shape of the upper side of the high building or the shape of the side surface or back side of the building is unclearly recognized or cannot be recognized.

Since the 3D model 20 is based on the point cloud data acquired through the SLAM, for example, it is possible to detect which region is a plane and on which region an object is present (whether there is height information) on the basis of three-dimensional coordinate information. Furthermore, the client 100 can also generate a two-dimensional image of the 3D model 20 observed from a specific viewpoint.

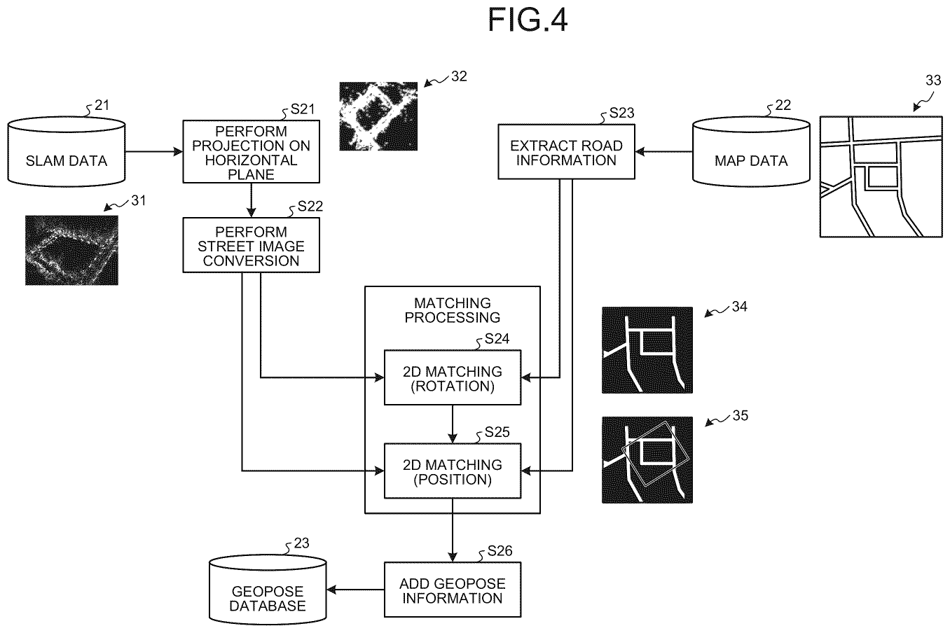

Next, a method of collating the point cloud data used in the SLAM with the map service will be described with reference to FIG. 4. FIG. 4 is a diagram for describing the collation processing according to the embodiment. Note that, in the following, an example will be described in which the VPS server 200 sets geopose information in data captured by the client 100 and collates the data with the map service, but such processing may be executed by the client 100.

The VPS server 200 accumulates the feature points extracted from the image data transmitted from the client 100 as SLAM data 21. An image 31 is obtained by plotting and visualizing the SLAM data 21 on a three-dimensional space. Note that the SLAM data 21 may be captured by the client 100 and then held by the VPS server 200.

Thereafter, the VPS server 200 projects the point cloud data generated on the basis of the SLAM data 21 on a horizontal plane (Step S21). For example, the VPS server 200 generates a two-dimensional image 32 by projecting feature point information extracted from the SLAM data 21 on a horizontal plane. Specifically, in a case where a height component is z in the point cloud data included in the SLAM data 21, the VPS server 200 generates the image 32 by performing planar mapping by using only the remaining x and y components.

Subsequently, the VPS server 200 converts the image 32 into a street image (Step S22). Specifically, the VPS server 200 converts the image 32 into a street image by using an image conversion model or the like using a deep neural network (DNN), such as Pix2pix. That is, the VPS server 200 generates the image 32 to clarify information indicating which position of the SLAM data 21 corresponds to road information.

Furthermore, the VPS server 200 accesses the database to acquire map data 22, and extracts road information from the map data 22 (Step S23). At this time, the VPS server 200 may transmit rough positional information of the first region to the VPS server 200 on the basis of global positioning system (GPS) information transmitted from the client 100 in addition to the image, and may specify the map data 22 corresponding to the first region. As described above, the map data 22 is provided in a vector tile format. Note that an image 33 is a conceptual diagram in which the map data 22 is represented two-dimensionally. Furthermore, the map data 22 itself may not be held by the VPS server 200 but may be held by the service server 300.

Subsequently, the VPS server 200 executes matching processing between the image 32 subjected to the street image conversion and an image 34 including the road information extracted in Step S23 (Step S24). The image 34 is obtained by extracting the road information with the current location as a reference from the map data 22 included in the service server 300. First, the VPS server 200 performs matching processing for aligning rotations in the 2D matching (Step S24). Specifically, the VPS server 200 performs pattern matching on both images, and specifies which aspect of the road information of the map data 22 (that is, the map service) the street image generated from the SLAM data 21 matches. For example, the VPS server 200 specifies that the road information in the range indicated by the image 34 matches the image 32.

Subsequently, the VPS server 200 performs matching processing for aligning positions in the 2D matching (Step S25). Specifically, the VPS server 200 rotates the street image generated from the SLAM data 21 on the basis of the pattern matching of both images to match the road position in an image 35. Note that, in the processing of Step S24 and Step S25, the VPS server 200 can speed up the entire processing by adjusting the resolution required for the processing, for example, by using a high-resolution street image for the matching for the position and by using a low-resolution street image for the matching for the rotation.

The VPS server 200 adds geopose information to the information corresponding to the set of feature points (keyframe) of the SLAM data 21 by using the rotation and position information that can be matched (Step S26). That is, with such processing, the VPS server 200 and the client 100 can obtain the position corresponding to the first 3D model as latitude/longitude information of the real world. Such processing is referred to as global conversion or the like.

Then, the VPS server 200 registers the added geopose information in a geopose database 23.

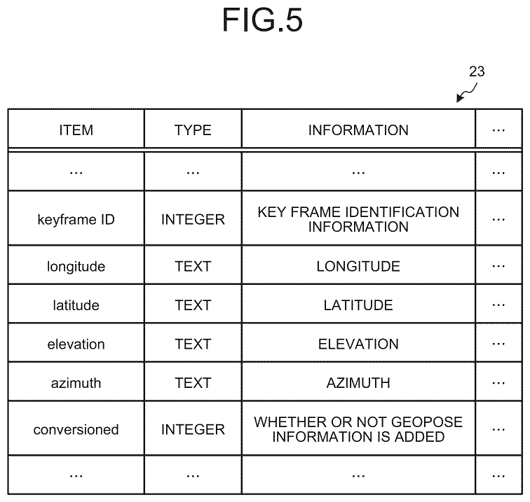

The geopose information will be described with reference to FIG. 5. FIG. 5 is a diagram illustrating an example of the geopose database 23 according to the embodiment.

As illustrated in FIG. 5, the geopose database 23 includes items such as “keyframe ID”, “longitude”, “latitude”, “elevation”, “azimuth”, and “conversioned”. “Type” indicates in what format the information of each item is stored. “Information” indicates specific content of each item. For example, the example illustrated in FIG. 5 indicates that values such as “key frame identification information”, “latitude”, “longitude”, “elevation”, and “azimuth”, information indicating whether or not geopose information has been assigned (for example, “zero” is recorded in the GPS as it is, and “one” is recorded after the global conversion), and the like are stored in the data (field) included in the geopose database 23.

As described above, with reference to FIGS. 4 and 5, the VPS server 200 can match the point cloud data with the position on the map by associating the SLAM data captured by the client 100 with the geopose information.

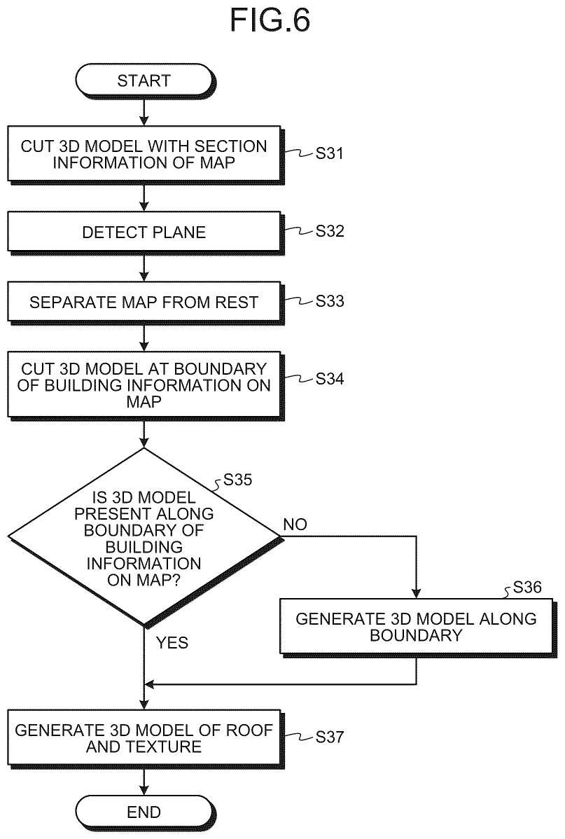

Next, division processing of the 3D model will be described with reference to FIG. 6 and subsequent drawings. First, an overview of a flow of the division processing will be described with reference to FIG. 6.

The client 100 acquires map data that matches the 3D model on the basis of the geopose information, and cuts the first 3D model by using the acquired section information of the map (Step S31). Thereafter, the client 100 performs plane detection on the cut 3D model (Step S32). As a result, the client 100 can divide the ground and the rest in the 3D model (Step S33).

Thereafter, the client 100 further cuts the 3D model at the boundary of building information on the map (Step S34). Subsequently, the client 100 determines whether or not a 3D model is present along the boundary of the building information on the map (Step S35). The fact that there is no 3D model along the boundary means that there is no side surface or back surface of the building of the cut 3D model.

When it is determined that the 3D model is not present along the boundary of the building information on the map (Step S35; No), the client 100 generates the 3D model along the boundary in order to generate the side surface and the back surface of the building (Step S36).

In a case where the 3D model is present along the boundary of the building information on the map (Step S35; Yes), the client 100 proceeds to the next step. Specifically, the client 100 generates a missing element in the 3D model, a 3D model of the roof of the object, or a texture (Step S37). This is because, since the first capture is performed by the user 10 on the ground, the shape and texture of the roof in the generated 3D model are unknown. At this time, the client 100 may generate the 3D model and texture of the roof of the building that cannot actually be captured from a satellite image or the like.

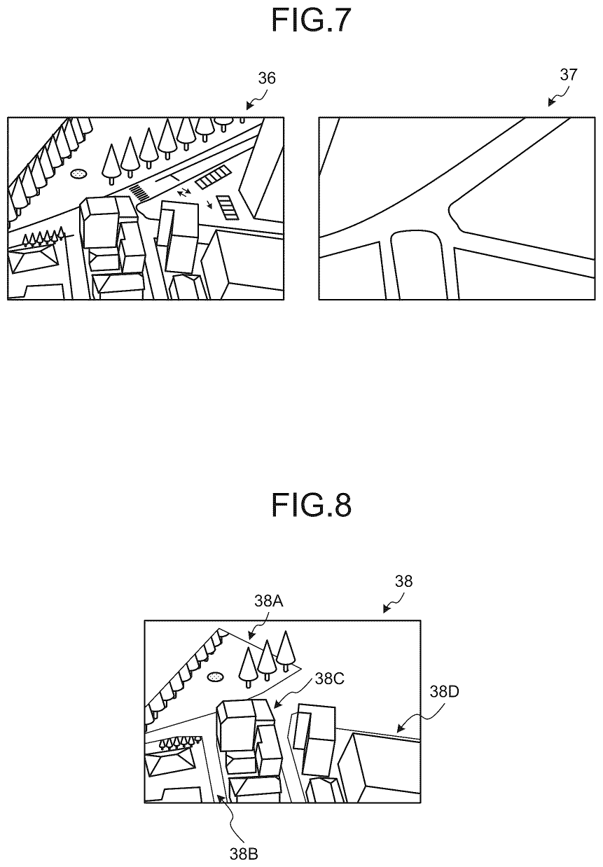

The division processing illustrated in FIG. 6 will be specifically described with reference to the conceptual diagrams of FIG. 7 and subsequent drawings. FIG. 7 is a diagram (1) for describing the division processing according to the embodiment.

An image 36 illustrated in FIG. 7 is a conceptual diagram of a 3D model illustrated from an obliquely upper viewpoint. Note that, in the following description, a 3D model generated on the basis of data captured from the sky, such as a satellite photograph will be described. Furthermore, an image 37 is a diagram illustrating data obtained by extracting only data to which a road attribute is assigned from the map data.

First, the client 100 collates the image 36 with the image 37. That is, the client 100 determines the positions of the image 36 and image 37 to match by using the geopose information acquired from the VPS server 200, and cuts and divides the entire 3D model in a vertical direction at the boundary of the section information (in this example, the road shown in the image 36).

FIG. 8 illustrates a conceptual diagram of the divided 3D model generated by the processing illustrated in FIG. 7. FIG. 8 is a diagram (2) for describing the division processing according to the embodiment. An image 38 illustrated in FIG. 8 includes a 3D model 38A, a 3D model 38B, a 3D model 38C, and a 3D model 38D, which are cut along the road as the boundary and divided.

Moreover, the client 100 performs plane detection on the divided 3D models to remove unnecessary information. That is, the client 100 detects a wide plane estimated to be the ground in each of the 3D models divided for each section. Note that the plane detection can be implemented by a method such as three-dimensional Hough transform. The Hough transform is a method of estimating a straight line or a plane that passes through the point cloud most frequently from the point cloud.

The client 100 performs plane detection, separates a plane estimated to be the ground from the 3D model before detection, and divides the 3D model such that unconnected 3D models become separate 3D models. Therefore, the client 100 can divide the original 3D model into 3D models with only objects (buildings, trees, and the like) having height information.

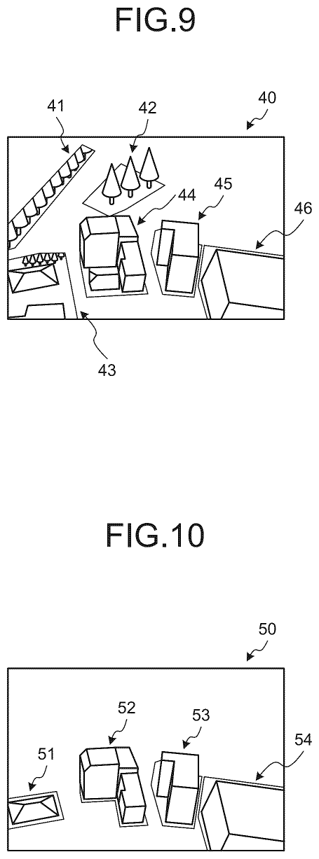

For example, the client 100 divides the original 3D model into the 3D models illustrated in FIG. 9. FIG. 9 is a diagram (3) for describing the division processing according to the embodiment. An image 40 illustrated in FIG. 9 includes a 3D model 41, a 3D model 42, a 3D model 43, a 3D model 44, a 3D model 45, and a 3D model 46, which are divided and from which planes are removed.

Moreover, the client 100 cuts the 3D model in the vertical direction with the boundary information of the building by using the data to which the building attribute is assigned in the map data. That is, the client 100 separates the 3D models including the individual buildings from the other adjacent 3D models. At this time, since whether or not the object included in the 3D model is a building can be determined from the map data, the client 100 leaves attribute information of a building in the 3D model of each building.

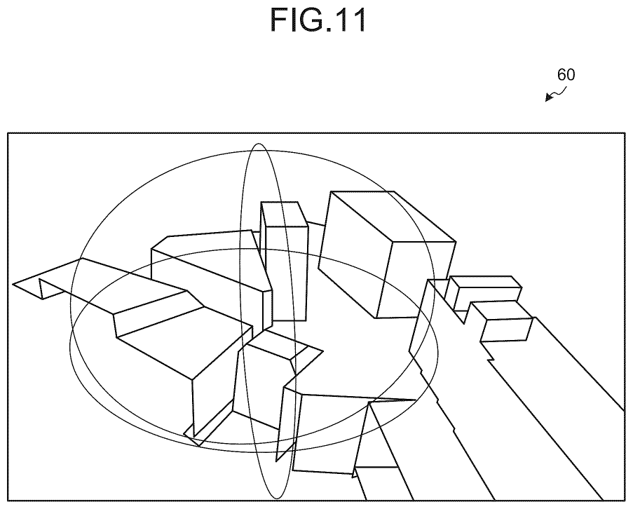

Through such processing, the client 100 obtains the 3D models illustrated in FIG. 10. FIG. 10 is a diagram (4) for describing the division processing according to the embodiment. An image 50 illustrated in FIG. 10 includes a 3D model 51, a 3D model 52, a 3D model 53, and a 3D model 54, which are divided and in which only the buildings are left.

Moreover, in a case where there is a 3D model along the boundary of the building information on the map, that is, in a case where a 3D model to which attribute information of a building is assigned is obtained in the processing up to FIG. 10, the client 100 may perform modification processing (simplification processing) on the 3D model. That is, the client 100 may generate a model of the back side portion of the building that cannot actually be captured from the building boundary information of the map information. As an example, when the boundary of the building on the map is a polygon, the client 100 can reproduce an approximate shape of the building by replacing a line segment of the polygon with one plane.

In the examples illustrated in FIGS. 7 to 10, since the 3D model is generated on the basis of a satellite photograph or the like, a building or the like can be displayed in a rectangular shape. However, in the 3D model generated by the user 10 capturing the real world from the ground, the building is not displayed in a rectangular shape, and the shape of the roof or the back side is ambiguous. In this case, the client 100 may generate a 3D model of the roof or the back side of the building that cannot actually be captured, or may generate a texture. Note that the client 100 can also acquire satellite photograph data of the surroundings matching the geopose information, and generate the texture of the roof of the 3D model from the image of the satellite photograph.

Through the above-described processing, the client 100 can newly generate a 3D model that includes only a building as an object and has positional information matching the map service.

That is, the client 100 can obtain a new 3D model 60 illustrated in FIG. 11 from the original 3D model. FIG. 11 is a diagram illustrating a second 3D model 60 according to the embodiment. Specifically, like the first 3D model 20 illustrated in FIG. 3, the client 100 generates the second 3D model 60 obtained by dividing a huge 3D model obtained by three-dimensionally shaping the point cloud data for each building and assigning a rectangular shape or the like to the building.

By registering the 3D model thus obtained in the map service, the service server 300 can provide various services to the user 10. As an example, the service server 300 can perform occlusion representation in which a virtual character is hidden in a building in the AR expression, or can perform collision determination of a virtual object. Furthermore, in a game simulating a real space, the service server 300 can also show individual buildings to be destroyed and erased. Moreover, the service server 300 may display the 3D model divided for each building on the 3D map service, and visualize the simulation in a case where the currently built building is dismantled and replaced with a new building.

Furthermore, the service server 300 can also provide a user on the site with an experience made by combining the 3D map services, for example, a user who uses the 3D map service remotely performs some action. Specifically, the service server 300 can pick up individual buildings virtually displayed on the site from a remote place in an AR game application connecting the remote place and the site. Moreover, in a game set in a real space, the service server 300 can cause a character being played to be subjected to AR display in an actual building, and cause a user on the site to be capable of visually recognizing the character through a smartphone or the like.

As described above, the client 100 can flexibly use the 3D model in the service or the like by generating the divided 3D model that matches the actual positional information.

### 1-2. Configuration of Client According to Embodiment

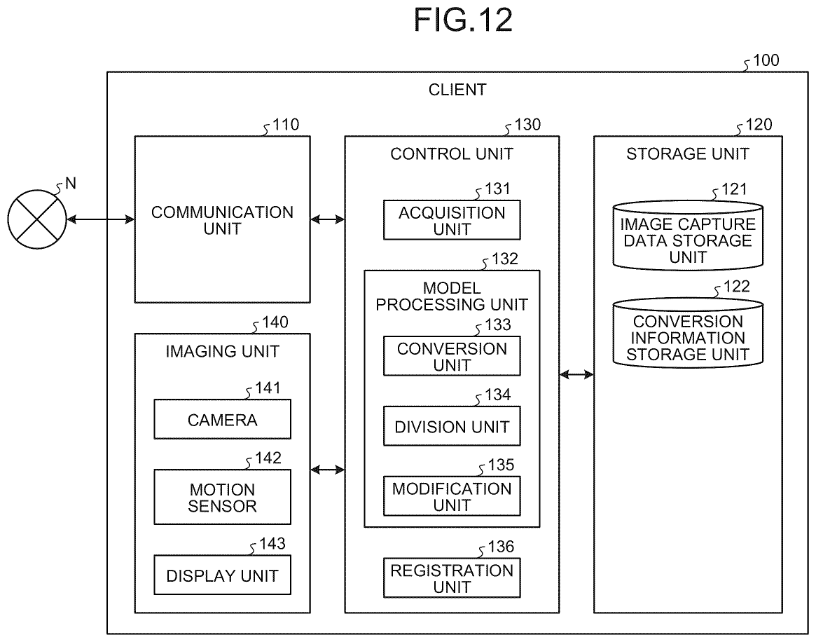

Next, a configuration of the client 100 will be described. FIG. 12 is a diagram illustrating a configuration example of the client 100 according to the embodiment.

As illustrated in FIG. 12, the client 100 includes a communication unit 110, a storage unit 120, a control unit 130, and an imaging unit 140. Note that the client 100 may include an input unit (for example, a touch display or the like) that receives various operations from an administrator or the like who manages the client 100, and an output unit (for example, a speaker, a display, or the like) for displaying various types of information.

For example, the communication unit 110 is implemented by a network interface card (NIC), a network interface controller, or the like. The communication unit 110 is connected to a network N in a wired or wireless manner, and transmits and receives information to and from the VPS server 200, the service server 300, and the like via the network N. For example, the network N is realized by a wireless communication standard or system such as Bluetooth (registered trademark), the Internet, Wi-Fi (registered trademark), Ultra Wide Band (UWB), Low Power Wide Area (LPWA), and ELTRES (registered trademark).

For example, the storage unit 120 is realized by a semiconductor memory element such as a random access memory (RAM) and a flash memory, or a storage device such as a hard disk and an optical disk. The storage unit 120 includes an image capture data storage unit 121 and a conversion information storage unit 122.

The image capture data storage unit 121 stores capture data captured by the client 100. The capture data may be image data or point cloud data acquired using a technology such as SLAM.

The conversion information storage unit 122 stores the first 3D model generated on the basis of the capture data, geopose information regarding first 3D model, and information regarding second 3D model. Note that the geopose database 23 illustrated in FIG. 5 may be included in the conversion information storage unit 122.

The imaging unit 140 is a functional unit that performs processing related to imaging. A camera 141 captures an imaging target as an image on the basis of the function of the image sensor. A motion sensor 142 is a device or a functional unit for detecting the motion of the client 100, and detects various types of information such as rotation, movement, acceleration, and a gyro. A display unit 143 is, for example, a liquid crystal display or the like, and displays an image or the like captured by the camera 141.

Note that the imaging unit 140 is not limited to the above-described example, and may be realized by various sensors. For example, the imaging unit 140 may include a sensor for measuring a distance to an object around the client 100. For example, the imaging unit 140 may include a light detection and ranging (LiDAR) that reads a three-dimensional structure of a surrounding environment of the client 100, a distance measurement system using a millimeter wave radar, and a depth sensor for acquiring depth data.

For example, the control unit 130 is realized by a central processing unit (CPU), a micro processing unit (MPU), a GPU, or the like executing a program (for example, an information processing program according to the present disclosure) stored in the client 100 by using a random access memory (RAM) or the like as a work area. Furthermore, note that the control unit 130 is a controller, and for example, may be realized by an integrated circuit such as an application specific integrated circuit (ASIC) or a field programmable gate array (FPGA).

As illustrated in FIG. 12, the control unit 130 includes an acquisition unit 131, a model processing unit 132, and a registration unit 136. The model processing unit 132 includes a conversion unit 133, a division unit 134, and a modification unit 135.

The acquisition unit 131 acquires various types of information. For example, the acquisition unit 131 acquires a first 3D model generated by capturing a first region in the real space and map data corresponding to the first region.

That is, the acquisition unit 131 acquires the first 3D model generated on the basis of the data captured by the imaging unit 140. Furthermore, the acquisition unit 131 acquires map data from the service server 300 on the basis of the positional information corresponding to the 3D model. Furthermore, when the first 3D model and the map data are collated with each other, the acquisition unit 131 acquires the geopose information (information regarding a latitude/longitude, elevation, and the like) corresponding to the first 3D model from the VPS server 200.

The model processing unit 132 executes processing of generating a second 3D model from the first 3D model. The model processing unit 132 includes a conversion unit 133, a division unit 134, and a modification unit 135. The conversion unit 133 performs global conversion processing illustrated in FIG. 4 and collates the first 3D model with the map data. As illustrated in FIGS. 6 to 10, the division unit 134 divides the first 3D model to generate the second 3D model. As illustrated in FIG. 11, the modification unit 135 modifies the second 3D model to a shape of a building or the like, or adds the texture of a roof. Hereinafter, processing executed by each of the conversion unit 133, the division unit 134, and the modification unit 135 will be described as processing executed by the model processing unit 132. Furthermore, the processing such as conversion into geopose information as described with reference to FIG. 4 can be executed by the client 100 instead of the VPS server 200. Therefore, in the following description, it is assumed that these processing are also executed by the model processing unit 132.

The model processing unit 132 divides the first 3D model into a plurality of second 3D models on the basis of the section information included in the map data acquired by the acquisition unit 131.

At this time, as described with reference to FIG. 4, since geopose information is assigned to the first 3D model on the basis of the collation between the first 3D model and the map data, that is, the model processing unit 132 can assign information regarding a latitude/longitude and elevation to a plurality of the second 3D models. Therefore, each of the divided second 3D models has the map data matching the position, and thus the divided second 3D model can be used in various services such as the map service.

Note that the model processing unit 132 collates the first 3D model with the map data by using the road information obtained by performing image conversion (for example, image conversion into a street image using DNN) on point cloud information corresponding to the first 3D model and the road information assigned to the map data as an attribute. The point cloud information corresponding to the first 3D model is, for example, the point cloud data of the SLAM of the image captured by the client 100.

More specifically, the model processing unit 132 performs pattern matching processing between the image corresponding to the first 3D model and the image corresponding to the map data, and rotates the images and moves the positions of the images such that the road information matches the images. Then, the model processing unit 132 specifies information regarding a latitude/longitude and elevation of the second 3D model by collating the first 3D model with the map data, and assigning information regarding a latitude/longitude and elevation to the first 3D model on the basis of the collated map data.

Furthermore, the model processing unit 132 divides the first 3D model into the second 3D models on the basis of the section information obtained by dividing the section with the road information included in the map data. For example, as described using an image 36 and an image 37 in FIG. 7, the model processing unit 132 obtains the second 3D models by dividing the road for each section. Note that, as described with reference to FIGS. 8 to 10, the model processing unit 132 deforms the second 3D models in units of objects (buildings) by applying various types of processing to the second 3D model, all the second 3D models are the divided 3D models and can be referred to as a second 3D model. That is, to what unit the model processing unit 132 deforms the second 3D models depends on the service, and the second 3D model is not necessarily required to be deformed to a building unit.

Furthermore, after dividing the first 3D model on the basis of the section information, the model processing unit 132 performs plane detection on the divided sections, and divides, as the second 3D model, only the section including an object not detected as a plane.

Moreover, the model processing unit 132 performs plane detection on a section including an object not detected as a plane, separates the section in a region estimated to be a plane, and divides only the separated section as a second 3D model. As a result, even in a case where a plane (ground or the like) is present in the divided 3D model instead of the boundary, the model processing unit 132 can obtain the 3D model from which the plane is further removed.

Furthermore, the model processing unit 132 further specifies an object that is a building on the basis of map data after separating the section in the region estimated to be a plane, and divides only the separated section including the specified object as the second 3D model. As a result, the model processing unit 132 can obtain a 3D model from which the objects such as trees having elevation information instead of buildings have been removed.

Furthermore, the model processing unit 132 may further specify the boundary of the building on the basis of the map data in the separated section including the specified object, and divide only the section separated at the specified boundary as the second 3D model. Therefore, the model processing unit 132 can further remove an unnecessary range from the divided 3D model and obtain only a building as a new 3D model.

Furthermore, the model processing unit 132 may modify the second 3D model by adding a planar shape to the object included in the second 3D model. For example, the model processing unit 132 may generate the model of the back side portion of the building from the boundary information of the building in the map information. As an example, when the boundary of the building on the map is a polygon, the model processing unit 132 can obtain a new 3D model in which the approximate shape of the building is reproduced by replacing a line segment of the polygon with one plane.

Furthermore, the model processing unit 132 may modify the object included in the second 3D model by using the image of the object included in the map data.

Specifically, the model processing unit 132 modifies the object included in the second 3D model by acquiring an image corresponding to the object from the satellite photograph included in the map data, extracting a texture of the roof of the object, and adding the extracted texture. As a result, the model processing unit 132 can generate a 3D model in which the image of a portion that cannot be captured by the user 10 is substantially accurately reproduced.

The registration unit 136 registers, in the map data, the second 3D model to which information regarding a latitude/longitude and elevation is assigned by the model processing unit 132. As a result, the registration unit 136 can use the new 3D model in various services.

### 1-3. Configuration of VPS Server According to Embodiment

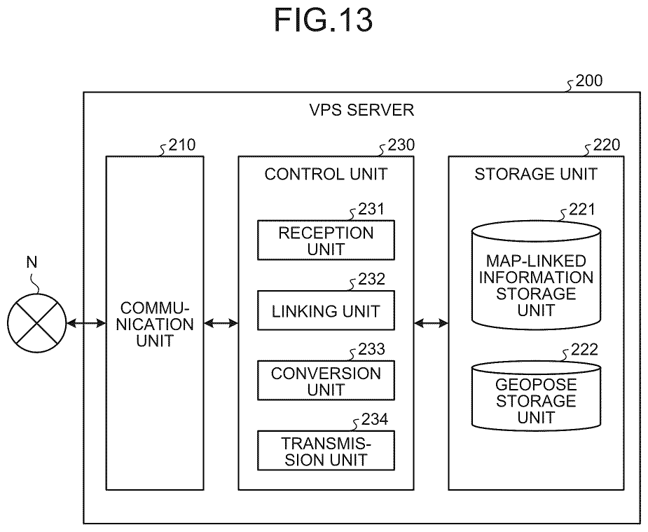

Next, a configuration of the VPS server 200 will be described. FIG. 13 is a diagram illustrating a configuration example of the VPS server 200 according to the embodiment.

As illustrated in FIG. 13, the VPS server 200 includes a communication unit 210, a storage unit 220, and a control unit 230.

The communication unit 210 is implemented by, for example, an NIC, a network interface controller, or the like. The communication unit 210 is connected to a network N in a wired or wireless manner, and transmits and receives information to and from the client 100 via the network N.

For example, the storage unit 220 is realized by a semiconductor memory element such as a RAM and a flash memory, or a storage device such as a hard disk and an optical disk. The storage unit 220 includes a map-linked information storage unit 221 and a geopose storage unit 222. The map-linked information storage unit 221 stores information in which the position/orientation information of the 3D model transmitted from the client 100 and the map data are linked. The geopose storage unit 222 stores geopose information corresponding to the 3D model. Note that the information stored in the map-linked information storage unit 221 and the geopose storage unit 222 may be stored by the client 100 as described above.

The control unit 230 is implemented by, for example, a CPU, an MPU, a GPU, or the like executing a program stored in the VPS server 200 by using a RAM or the like as a work area. Furthermore, the control unit 230 is a controller, and may be realized by, for example, an integrated circuit such as an ASIC or an FPGA.

As illustrated in FIG. 13, the control unit 230 includes a reception unit 231, a linking unit 232, a conversion unit 233, and a transmission unit 234.

The reception unit 231 receives, from the client 100, an image and GPS information when the image is acquired. As illustrated in FIG. 4, the linking unit 232 and the conversion unit 233 execute linking between the point cloud data and the map data, and conversion into geopose information. Note that, in a case where the conversion processing into the geopose information is executed by the client 100, the linking unit 232 and the conversion unit 233 appropriately provide information required for the processing of the client 100. The transmission unit 234 transmits, to the client 100, information required for processing by the client 100, such as geopose information.

### 1-4. Configuration of Service Server According to Embodiment

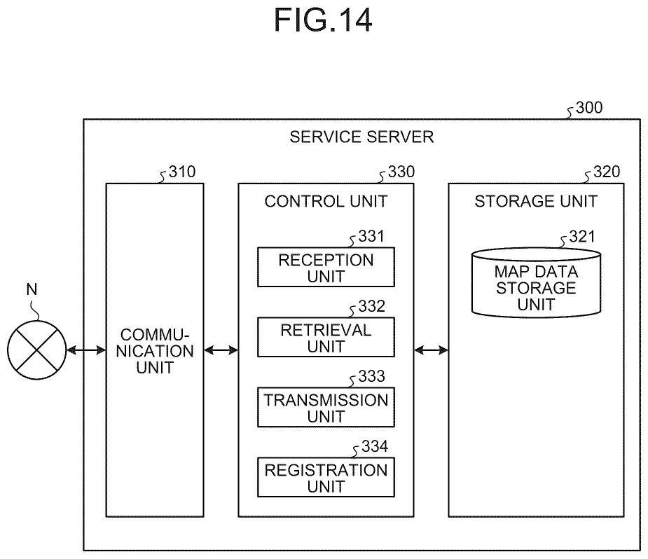

Next, a configuration of the service server 300 in the VPS server 200 will be described. FIG. 14 is a diagram illustrating a configuration example of the service server 300 according to the embodiment.

As illustrated in FIG. 14, the service server 300 includes a communication unit 310, a storage unit 320, and a control unit 330.

The communication unit 310 is implemented by, for example, an NIC, a network interface controller, or the like. The communication unit 310 is connected to a network N in a wired or wireless manner, and transmits and receives information to and from the client 100 via the network N.

For example, the storage unit 320 is realized by a semiconductor memory element such as a RAM and a flash memory, or a storage device such as a hard disk and an optical disk. For example, in a case where the service server 300 is a server that provides a map service, the storage unit 320 includes a map data storage unit 321 that stores map data.

The control unit 330 is implemented by, for example, a CPU, an MPU, a GPU, or the like executing a program stored in the service server 300 by using a RAM or the like as a work area. Furthermore, the control unit 330 is a controller, and may be realized by, for example, an integrated circuit such as an ASIC or an FPGA.

As illustrated in FIG. 14, the control unit 330 includes a reception unit 331, a retrieval unit 332, a transmission unit 333, and a registration unit 334.

The reception unit 331 receives a map data use request from the client 100. When receiving the request from the client 100, the retrieval unit 332 retrieves a rough position in the map data on the basis of, for example, GPS information included in the 3D model, and specifies the map data to be provided to the client 100. The transmission unit 333 transmits the map data to the client 100. In a case where there is a registration request for the 3D model from the client 100, the registration unit 334 specifies a position on the map on the basis of the geopose information of the 3D model and registers the 3D model on the map data.

### 1-5. Procedure of Processing According to Embodiment

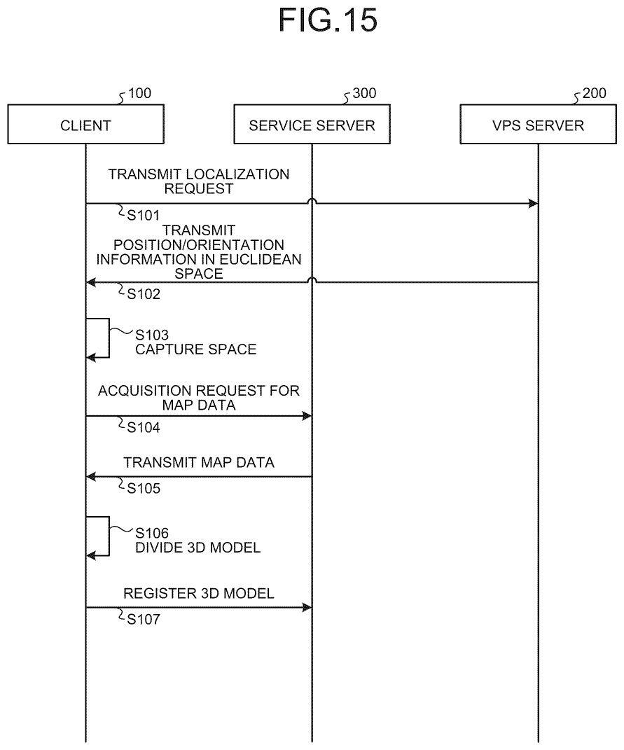

Next, a procedure of processing of the information processing system 1 according to the embodiment will be described with reference to FIG. 15. FIG. 15 is a sequence diagram illustrating a flow of the processing according to the embodiment.

As illustrated in FIG. 15, at the time of capturing, the client 100 transmits a localization request to the VPS server 200 (Step S101). Note that such processing is assumed to be periodically and continuously executed by the client 100 that executes capturing. In order to cause the VPS server 200 to use the image to narrow down the position, the client 100 may transmit GPS information indicating a rough position, a result of a position estimation service using Wi-Fi, base station information of a connected mobile phone, and the like together with the image. For example, in a case where 5th generation (G) has become widespread as a mobile phone communication network, the VPS server 200 can narrow down the area with an ID specific to an edge server.

In response to the request from the client 100, the VPS server 200 transmits the position/orientation information and the geopose information in the Euclidean space to the client 100 (Step S102). That is, the client 100 continuously acquires the position/orientation information and the geopose information on the basis of the captured image. Note that the client 100 and the VPS server 200 may acquire the map data from the service server 300 as necessary.

The client 100 acquires geopose information associated with an image and captures a space to generate a 3D model of a surrounding space associated with the geopose information (Step S103).

Thereafter, the client 100 transmits, to the service server 300, an acquisition request for map data for division processing (Step S104). The service server 300 transmits the requested map data to the client 100 (Step S105).

The client 100 divides the 3D model by using the section information included in the map data (Step S106). Then, the client 100 registers the divided 3D model in the service server 300 (Step S107).

### 1-6. Modification Example According to Embodiment

### (1-6-1. Modification of Information Processing System)

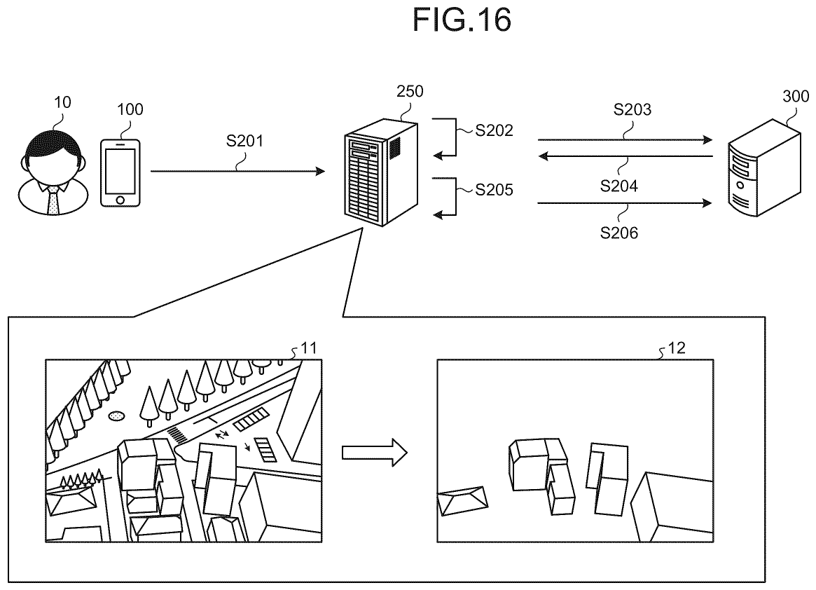

The above-described embodiment may involve various different modifications. For example, in the above-described embodiment, an example in which the client 100 generates the second 3D model has been described, but such processing may be executed by a VPS server 250 according to the modification example. This example will be described with reference to FIG. 16.

FIG. 16 is a diagram illustrating an overview of the information processing system 1 according to the modification example. As illustrated in FIG. 16, the client 100 transmits the captured image to the VPS server 250 (Step S201). The VPS server 250 converts the key frame of the image into geopose information (Step S202). The VPS server 250 specifies the geopose information, accesses the service server 300 (Step S203), and acquires the map data from the service server 300 (Step S204).

The VPS server 250 generates a first 3D model 11 on the basis of the image acquired from the client 100, and generates a second 3D model 12 on the basis of the collated map data (Step S205). Then, the VPS server 250 registers the generated second 3D model 12 to the map service (Step S206). Note that the VPS server 250 may transmit the generated first 3D model 11 and second 3D model 12 to the client 100.

In this manner, the generation of the 3D model may be executed by the VPS server 250. In general, since it is estimated that the VPS server 250 is faster than the client 100 which is an edge terminal in the 3D model generation processing, the information processing system 1 according to the modification example can speed up the processing.

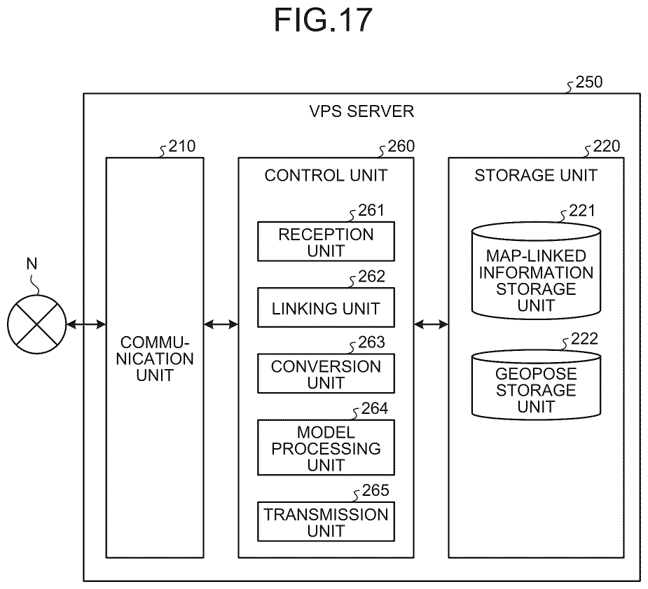

FIG. 17 is a diagram illustrating a configuration example of the VPS server 250 according to the modification example. As illustrated in FIG. 17, the VPS server 250 includes a control unit 260 instead of the control unit 230 illustrated in FIG. 13. The control unit 260 includes a model processing unit 264 in addition to the configuration of the control unit 230 illustrated in FIG. 13. The model processing unit 264 executes processing similar to that of the model processing unit 132 illustrated in FIG. 12.

### 1-6-2. Modification of Subject Executing Information Processing

As in the above-described modification example, the information processing described in the present disclosure may be executed mainly by any of the devices included in the information processing system 1. For example, the client 100 may execute the geopose information conversion (assignment) processing illustrated in FIG. 4 by its own device.

### (1-6-3. Device Type)

In the above-described embodiment, an example in which the client 100 is a smartphone or the like has been described. However, the client 100 is not limited to a smartphone, a tablet terminal, or the like, and may be any device as long as the client 100 is a device that can capture the real space and can execute AR processing. For example, examples of the client 100 may include a glasses-type device, a head mount display (HMD), and various wearable devices. Furthermore, the client 100 may be realized by two or more types of devices such as a digital camera and a device capable of communicating with the digital camera. Furthermore, the VPS server 200 and the service server 300 may not be separate devices but may be integrated.

### 2. Another Embodiment

The processing according to each embodiment described above may be performed in various different modes other than each embodiment described above.

Furthermore, among the processing described in the embodiments described above, all or a part of the processing described as being performed automatically can be performed manually, or all or a part of the processing described as being performed manually can be performed automatically by a known method. In addition, a processing procedure, a specific name, and information including various data and parameters, which are described in the document and the drawings can be arbitrarily changed unless otherwise specified. For example, various information illustrated in each drawing are not limited to the illustrated information.

Furthermore, each constituent element of each device illustrated in the drawings is functionally conceptual element, and is not necessarily physically configured as illustrated in the drawings. That is, a specific form of distribution and integration of each device is not limited to the illustrated form, and all or a part thereof can be functionally or physically distributed or integrated in an arbitrary unit in accordance with various loads, usage states, and the like. For example, the model processing unit 132 and the registration unit 136 may be integrated.

Furthermore, the above-described embodiments and the modification example can be appropriately combined in a range in which the processing contents do not contradict each other.

Furthermore, the effects described in the present specification are merely examples and are not limited, and other effects may be obtained.

### 3. Effects of Information Processing Device According to Present Disclosure

As described above, the information processing device (the client 100 in the embodiment) according to the present disclosure includes an acquisition unit (the acquisition unit 131 in the embodiment) and a model processing unit (the model processing unit 132 in the embodiment). The acquisition unit acquires a first 3D model generated by capturing a first region in the real space and map data corresponding to the first region. The model processing unit divides the first 3D model into a plurality of second 3D models on the basis of the section information included in the map data.

As described above, the information processing device according to the present disclosure enables flexible use of the 3D model by dividing the 3D model on the basis of the section information.

Furthermore, the model processing unit assigns information regarding a latitude/longitude and elevation to a plurality of the second 3D models on the basis of collation between the first 3D model and the map data.

In this manner, the information processing device can provide a 3D model collatable with a map service or the like by assigning latitude/longitude information or the like to the divided 3D model.

Furthermore, the model processing unit collates the first 3D model with the map data by using the road information obtained by performing image conversion on point cloud information corresponding to the first 3D model and the road information assigned to the map data as an attribute.

As described above, the information processing device performs collation on the basis of the road information, and thus the information processing device can accurately perform the collation even with respect to an image with insufficient information, which is captured by the user or a 3D model.

Furthermore, the model processing unit performs pattern matching processing between the image corresponding to the first 3D model and the image corresponding to the map data, collates the first 3D model with the map data by rotating the images and moving the position such that road information matches the images, and specifies information regarding a latitude/longitude and elevation of the second 3D model by assigning information regarding a latitude/longitude and elevation to the first 3D model on the basis of the collated map data.

In this manner, the information processing device can provide more accurate latitude/longitude information with less error to the 3D model by performing collation based on pattern matching and then performing collation with the map data.

Furthermore, the information processing device further includes a registration unit (the registration unit 136 in the embodiment) that registers, in the map data, the second 3D model to which information regarding a latitude/longitude and elevation is assigned by the model processing unit.

As described above, by registering the second 3D model, the information processing device can provide a service that improves user experience in a service that performs AR processing or the like or a service that uses three-dimensional map data.

Furthermore, the model processing unit divides the first 3D model into the second 3D models on the basis of the section information obtained by dividing the section with the road information included in the map data.

In this manner, the information processing device can divide the 3D model into meaningful regions when dividing the 3D model by using the road information.

Furthermore, after dividing the first 3D model on the basis of the section information, the model processing unit performs plane detection on the divided sections, and divides only the section including an object not detected as a plane as the second 3D model.

In this manner, the information processing device can remove a model that is relatively not utilized as an object, such as a wide ground or a park, by performing plane detection and division, and can divide only a useful model.

Furthermore, the model processing unit further performs plane detection on a section including an object not detected as a plane, separates the section in a region estimated to be a plane, and divides only the separated section as a second 3D model.

In this manner, the information processing device can divide only a model with high probability including only a more useful object by also separating the ground and the like included in the section.

Furthermore, the model processing unit further specifies an object that is a building on the basis of map data after separating the section in the region estimated to be a plane, and divides only the separated section including the specified object as the second 3D model.

In this manner, the information processing device can divide only the 3D model that is expected to be more utilized by dividing only the object to which a building is assigned as an attribute information.

Furthermore, the model processing unit further specifies the boundary of the building on the basis of the map data in the separated section including the specified object, and divides only the section separated at the specified boundary as the second 3D model.

In this manner, the information processing device can generate the 3D model including only the building more accurately by dividing the model with the boundary information of the building.

Furthermore, the model processing unit modifies the second 3D model by adding a planar shape to the object included in the second 3D model.

As described above, by modifying the object to have a rectangular shape or the like, the information processing device can utilize even an amorphous object captured by the user as an object indicating a building in a map service or an AR service.

Furthermore, the model processing unit modifies the object included in the second 3D model by using the image of the object included in the map data.

As described above, in a case where an image obtained by imaging the object can be used, the information processing device can generate a 3D model closer to the real world by modifying the object using such an image.

Furthermore, the model processing unit modifies the object included in the second 3D model by acquiring an image corresponding to the object from the satellite photograph included in the map data, extracting a texture of the roof of the object, and adding the extracted texture.

As described above, the information processing device can approximate the texture of the roof in the 3D model, which is difficult to reproduce by a normal method, to that in the real world by using the satellite photograph.

### 4. Hardware Configuration

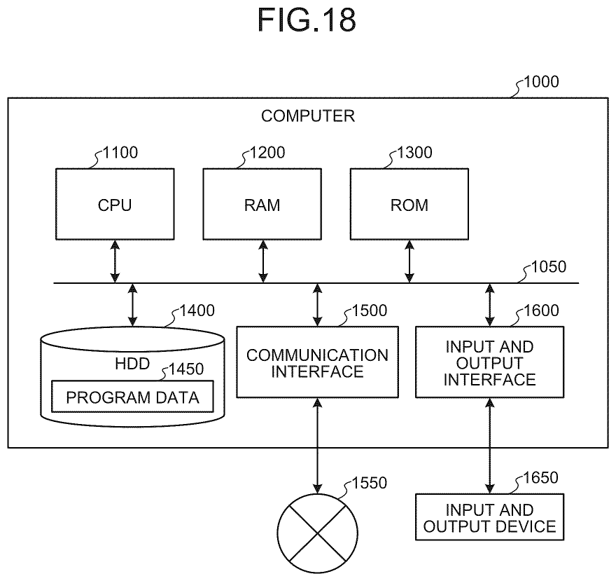

An information device such as the client 100 according to the embodiments described above is implemented by, for example, a computer 1000 having a configuration as illustrated in FIG. 18. Hereinafter, the client 100 according to the present disclosure will be described as an example. FIG. 18 is a hardware configuration diagram illustrating an example of the computer 1000 that implements a function of the client 100. The computer 1000 includes a CPU 1100, a RAM 1200, a read only memory (ROM) 1300, a hard disk drive (HDD) 1400, a communication interface 1500, and an input and output interface 1600. Units of the computer 1000 are connected with each other by a bus 1050.

The CPU 1100 operates on the basis of a program stored in the ROM 1300 or the HDD 1400, and controls each unit. For example, the CPU 1100 deploys the program stored in the ROM 1300 or the HDD 1400 on the RAM 1200, and executes processing corresponding to various programs. The ROM 1300 stores a boot program such as a basic input output system (BIOS) executed by the CPU 1100 when the computer 1000 is started, and a program, and the like that depends on hardware of the computer 1000.

The HDD 1400 is a computer-readable recording medium that non-temporarily records a program executed by the CPU 1100 and data used by the program. Specifically, the HDD 1400 is a recording medium that records an information processing program according to the present disclosure, which is an example of program data 1450.

The communication interface 1500 is an interface for connecting the computer 1000 to an external network 1550 (for example, Internet). For example, the CPU 1100 receives data from other devices or transmits data generated by the CPU 1100 to other devices via the communication interface 1500.

The input and output interface 1600 is an interface for connecting an input and output device 1650 to the computer 1000. For example, the CPU 1100 receives data from an input device such as a keyboard or a mouse via the input and output interface 1600. Furthermore, the CPU 1100 transmits data to an output device such as a display, a speaker, or a printer via the input and output interface 1600. Furthermore, the input and output interface 1600 may function as a medium interface for reading a program or the like recorded in a predetermined recording medium (media). For example, the medium is an optical recording medium such as a digital versatile disc (DVD) or a phase change rewritable disk (PD), a magneto-optical recording medium such as a magneto-optical disk (MO), a tape medium, a magnetic recording medium, or a semiconductor memory.

For example, in a case where the computer 1000 functions as the client 100 according to the embodiment, the CPU 1100 of the computer 1000 implements the function of the control unit 130 by executing the information processing program loaded on the RAM 1200. Furthermore, the HDD 1400 stores the information processing program according to the present disclosure and data in the storage unit 120. Note that the CPU 1100 reads the program data 1450 from the HDD 1400 and executes the program, but as another example, these programs may be acquired from other devices via the external network 1550.

Note that, the present technology can also have the following configurations.

(1) An information processing device comprising:
an acquisition unit that acquires a first 3D model generated by capturing a first region in a real space and map data corresponding to the first region; and a model processing unit that divides the first 3D model into a plurality of second 3D models on a basis of section information included in the map data.
   (2) The information processing device according to (1),
wherein the model processing unit
assigns information regarding a latitude/longitude and elevation to each of the plurality of second 3D models on a basis of collation between the first 3D model and the map data.
   (3) The information processing device according to (2),
wherein the model processing unit
collates the first 3D model with the map data by using road information obtained by performing image conversion on point cloud information corresponding to the first 3D model and road information assigned to the map data as an attribute.
   (4) The information processing device according to (3),
wherein the model processing unit
performs pattern matching processing between an image corresponding to the first 3D model and an image corresponding to the map data, collates the first 3D model with the map data by rotating the images and moving the position such that road information matches the images, and specifies the information regarding a latitude/longitude and elevation of the second 3D model by assigning the information regarding a latitude/longitude and elevation to the first 3D model on a basis of the collated map data.
   (5) The information processing device according to any one of (2) to (4), further comprising
a registration unit that registers, in the map data, the second 3D model to which the information regarding a latitude/longitude and elevation is assigned by the model processing unit.
   (6) The information processing device according to any one of (1) to (5),
wherein the model processing unit
divides the first 3D model into the second 3D models on a basis of the section information obtained by dividing a section with the road information included in the map data.
   (7) The information processing device according to (6),
wherein after dividing the first 3D model on a basis of the section information, the model processing unit
performs plane detection on the divided section, and divides only the section including an object not detected as a plane as the second 3D model.
   (8) The information processing device according to (7),
wherein the model processing unit
further performs the plane detection on the section including the object not detected as a plane, separates the section in a region estimated to be a plane, and divides only the separated section as the second 3D model.
   (9) The information processing device according to (8),
wherein after separating the section in the region estimated to be a plane, the model processing unit
further specifies an object that is a building on a basis of the map data, and divides only the separated section including the specified object as the second 3D model.
   (10) The information processing device according to (9),
wherein the model processing unit
further specifies a boundary of the building on a basis of the map data in the separated section including the specified object, and divides only the section separated at the specified boundary as the second 3D model.
   (11) The information processing device according to (9) or (10),
wherein the model processing unit
modifies the second 3D model by adding a planar shape to the object included in the second 3D model.
   (12) The information processing device according to any one of (9) to (11),
wherein the model processing unit
modifies the object included in the second 3D model by using an image of the object included in the map data.
   (13) The information processing device according to (12),
wherein the model processing unit
modifies the object included in the second 3D model by acquiring an image corresponding to the object from a satellite photograph included in the map data, extracting a texture of a roof of the object, and adding the extracted texture.
   (14) An information processing method, by a computer, comprising:
acquire a first 3D model generated by capturing a first region in a real space and map data corresponding to the first region; and
divide the first 3D model into a plurality of second 3D models on a basis of section information included in the map data.
   (15) An information processing program causing a computer to function as:
an acquisition unit that acquires a first 3D model generated by capturing a first region in a real space and map data corresponding to the first region; and
a model processing unit that divides the first 3D model into a plurality of second 3D models on a basis of section information included in the map data.

### REFERENCE SIGNS LIST

1 INFORMATION PROCESSING SYSTEM
10 USER
100 CLIENT
110 COMMUNICATION UNIT
120 STORAGE UNIT
121 IMAGING DATA STORAGE UNIT
122 CONVERSION INFORMATION STORAGE UNIT
130 CONTROL UNIT
131 ACQUISITION UNIT
132 MODEL PROCESSING UNIT
133 CONVERSION UNIT
134 DIVISION UNIT
135 MODIFICATION UNIT
136 REGISTRATION UNIT
140 IMAGING UNIT
200 VPS SERVER
300 SERVICE SERVER

The invention claimed is:

1. An information processing device comprising:
an acquisition unit that acquires a first 3D model generated by capturing a first region in a real space and map data corresponding to the first region; and
a model processing unit that divides the first 3D model into a plurality of second 3D models on a basis of section information included in the map data.

2. The information processing device according to claim 1,
wherein the model processing unit
assigns information regarding a latitude/longitude and elevation to each of the plurality of second 3D models on a basis of collation between the first 3D model and the map data.

3. The information processing device according to claim 2,
wherein the model processing unit
collates the first 3D model with the map data by using road information obtained by performing image conversion on point cloud information corresponding to the first 3D model and road information assigned to the map data as an attribute.

4. The information processing device according to claim 3,
wherein the model processing unit
performs pattern matching processing between an image corresponding to the first 3D model and an image corresponding to the map data, collates the first 3D model with the map data by rotating the images and moving the position such that road information matches the images, and specifies the information regarding a latitude/longitude and elevation of the second 3D model by assigning the information regarding a latitude/longitude and elevation to the first 3D model on a basis of the collated map data.

5. The information processing device according to claim 2, further comprising
a registration unit that registers, in the map data, the second 3D model to which the information regarding a latitude/longitude and elevation is assigned by the model processing unit.

6. The information processing device according to claim 1,
wherein the model processing unit
divides the first 3D model into the second 3D models on a basis of the section information obtained by dividing a section with the road information included in the map data.

7. The information processing device according to claim 6,
wherein after dividing the first 3D model on a basis of the section information, the model processing unit
performs plane detection on the divided section, and divides only the section including an object not detected as a plane as the second 3D model.

8. The information processing device according to claim 7,
wherein the model processing unit
further performs the plane detection on the section including the object not detected as a plane, separates the section in a region estimated to be a plane, and divides only the separated section as the second 3D model.

9. The information processing device according to claim 8,
wherein after separating the section in the region estimated to be a plane, the model processing unit
further specifies an object that is a building on a basis of the map data, and divides only the separated section including the specified object as the second 3D model.

10. The information processing device according to claim 9,
wherein the model processing unit
further specifies a boundary of the building on a basis of the map data in the separated section including the specified object, and divides only the section separated at the specified boundary as the second 3D model.

11. The information processing device according to claim 10,
wherein the model processing unit
modifies the second 3D model by adding a planar shape to the object included in the second 3D model.

12. The information processing device according to claim 10,
wherein the model processing unit
modifies the object included in the second 3D model by using an image of the object included in the map data.

13. The information processing device according to claim 12,
wherein the model processing unit
modifies the object included in the second 3D model by acquiring an image corresponding to the object from a satellite photograph included in the map data, extracting a texture of a roof of the object, and adding the extracted texture.

14. An information processing method, by a computer, comprising:
acquire a first 3D model generated by capturing a first region in a real space and map data corresponding to the first region; and
divide the first 3D model into a plurality of second 3D models on a basis of section information included in the map data.

15. An information processing program causing a computer to function as:
an acquisition unit that acquires a first 3D model generated by capturing a first region in a real space and map data corresponding to the first region; and
a model processing unit that divides the first 3D model into a plurality of second 3D models on a basis of section information included in the map data.
